(19) United States
(12) Patent Application Publication
(10) Pub. No.: US 2010/0139114 A1
(43) Pub. Date: Jun. 10, 2010

(54) METHOD FOR REFRESHING CLOTHES

(76) Inventors: Sog-Kie Hong, Seoul (KR); Myoung-Hun Im, Kyunggi-do (KR); Tae-Hee Lee, Kyunggi-do (KR)

Correspondence Address: KED & ASSOCIATES, LLP, P.O. Box 221200, Chantilly, VA, 20153-1200, US

(21) Appl. No.: 12/066,596

(22) PCT Filed: Nov. 10, 2006
(86) PCT No.: PCT/KR2006/004690

§ 371 Date: Mar. 14, 2008

(51) Int. Cl. F26B 7/00

(52) U.S. Cl. 34/389

(57) ABSTRACT

A method of refreshing clothing includes primarily drying the clothing by operating a fan; supplying steam generated by a steam generation unit to the clothing; and drying the clothing by operating the fan after the steam is supplied.

### TECHNICAL FIELD

The present invention relates to a method of refreshing clothing and, more particularly, a method of refreshing clothes using a cloth refreshing apparatus in which a steam supplying function cooperates with a drying function.

### BACKGROUND ART

A clothing refreshing apparatus is for reserving and refreshing clothing therein. The clothing refreshing apparatus performs a function for removing a wrinkle/odor from the clothing received therein using a steam and a hot wind. By this function, the order particles are removed from the clothing or wrinkled clothes are flattened.

A steam generation unit is provided in the clothing refreshing apparatus. The steam generation unit includes a water tank and a heater. That is, the water is heated by the heater to generate the steam.

In the conventional clothe refreshing apparatus, the water is continuously fed to the steam generation unit even during the steam is supplied to clothe. Therefore, when cool water is supplied, the steam is not continuously generated. In addition, the time taken for generating a required amount of the steam is longer.

### DISCLOSURE OF INVENTION

### Technical Problem

Accordingly, the present invention is directed to a method of refreshing clothing that substantially obviates one or more problems due to limitations and disadvantages of the related art.

An object of the present invention is to provide a method of refreshing clothe that can shorten the time for required for refreshing clothe by continuously supplying the steam.

Another object of the present invention is to provide a method of refreshing clothing that can perform a drying process after the steaming process so that the clothing accessibility can be improved.

### Technical Solution

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of refreshing clothing, including: primarily drying the clothing by operating a fan; supplying steam generated by a steam generation unit to the clothing; and drying the clothing by operating the fan after the steam is supplied.

According to another aspect of the present invention, there is provided a method of refreshing clothing, including: drying the clothing during a period where water in a steam generation unit is heated up to a temperature at which the water can be phase-changed into steam.

### ADVANTAGEOUS EFFECTS

According to the present invention, a primary drying is performed during a water feeding and heating processes and a secondary drying is performed after the steaming process. Therefore, the clothing refreshing can be continuously realized.

In addition, since the drying process and the steam feeding process are alternately realized, the time taken for refreshing the clothing can be reduced.

In addition, since the drying is realized during the water feeding process or the water heating process, the clothing refreshing time can be efficiently used.

Further, since no water is fed during the steam is fed, the steam feeding interruption due to the feeding of the cool water can be prevented. That is, the steam can be continuously fed.

In addition, since the heater is operation right after the water feeding starts or when the water is fed to a predetermined level, the standby time for the generation of the steam can be reduced.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a clothing refreshing apparatus used for performing a method of refreshing apparatus of the present invention;

FIG. 2 is a perspective view of a steam generation unit according to an embodiment of the present invention;

FIG. 3 is a flowchart illustrating a method of refreshing clothing according to a first embodiment of the present invention; and

FIG. 4 is a flowchart illustrating a method of refreshing clothing according to a second embodiment of the present invention.

### BEST MODE FOR CARRYING OUT THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

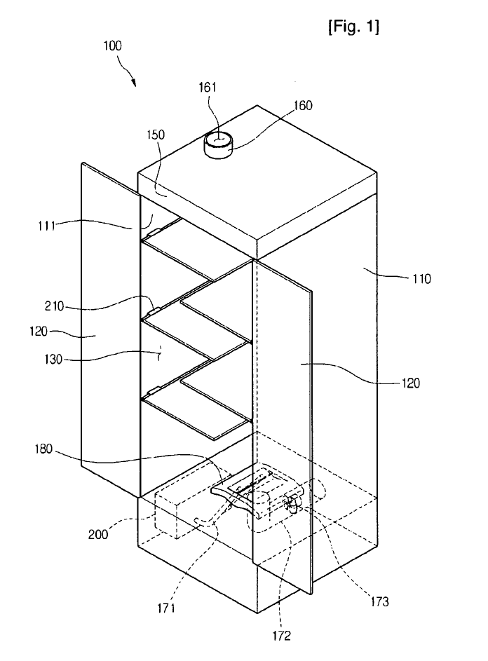

FIG. 1 is a clothing refreshing apparatus used for performing a method of refreshing apparatus of the present invention.

Referring to FIG. 1, a clothing refreshing apparatus 100 of the present invention includes a casing 110 provided with a clothing receiving hole 13 therein, a door 120 opening and closing the casing 110, a steam generation unit 200 provided under the casing 110, a nozzle 180 for supplying steam generated from the steam generation unit 200 to the clothing receiving hole 130, a team supplying tube 171 connecting the steam generation unit 200 to the nozzle 180, a drying duct 172 for supplying drying air to the clothing receiving hole 130, and a drying fan 172 provided in the drying duct 172.

When the drying fan 173 rotates, indoor air is introduced into the drying duct 160 and exhausted to the clothing receiving hole 130.

An exhaust duct 16 is provided on an upper portion of the casing 110 and the steam and drying air are exhausted to the indoor room through the exhaust hole 161 formed in the exhaust duct 160.

One or more racks 190 on which the clothing that will be refreshed are installed in the clothing refreshing apparatus 100. The racks 190 are mounted on an inner wall of the casing 110 by a hinge 210. The racks 190 are foldable upward and downward so that they can be easily handled.

The racks 190 provided on the inner wall of the casing 110 are staggered on opposite inner surfaces of the casing 110. For example, one of the racks 190 is installed on a left inner wall of the casing 110 and another one of the racks 190 is installed on a right inner wall of the casing 110. The racks 190 installed on the left inner wall and the racks 190 installed on the right inner wall are staggered in the vertical direction. A length of the rack 190 is less than a width of the clothing receiving hole 130 by a predetermined length. Then, the rack 190 is spaced apart from one inner wall facing another inner wall on which the rack 190 is installed.

That is, the spaced distance between the rack 190 and the inner wall of the casing 110 becomes a fluid passage along which the steam and drying air are fed into the clothing receiving hole 130. The fluid passage is formed in a meander line so that the steam and drying air can be sufficiently socked into the clothing.

The following will describe the operation of the clothing refreshing apparatus 100.

First, the clothing is loaded on the rack 190 and the rack 190 is received in the clothing receiving hole 130. In addition, the clothing may be received in the clothing receiving hole 130 using a separate rack.

In the drying process of the clothing refreshing apparatus 200, the drying fan 173 operates. Then, then, an air current is generated and thus external air is introduced into the drying duct 172. The introduced air passes through the drying duct 172 and is subsequently exhausted through the exhaust hole. The exhausted air contacts the clothing while rising through the fluid passage defined between the racks 190.

Meanwhile, in the steaming process of the clothing refreshing apparatus 200, electric power is applied to the steam generation unit 200 to generate the steam. The generated steam is sprayed into the clothing receiving hole 130 and socked into the clothing while rising through the fluid passage. The steam socked into the clothing removes the offensive smell or wrinkles of the clothing.

Meanwhile, the drying air or steam is exhaust to the indoor room through the exhaust hole 161. Here, the exhaust duct 160 is connected to a separated duct to exhaust the air or steam drawn out of the clothing receiving hole 130.

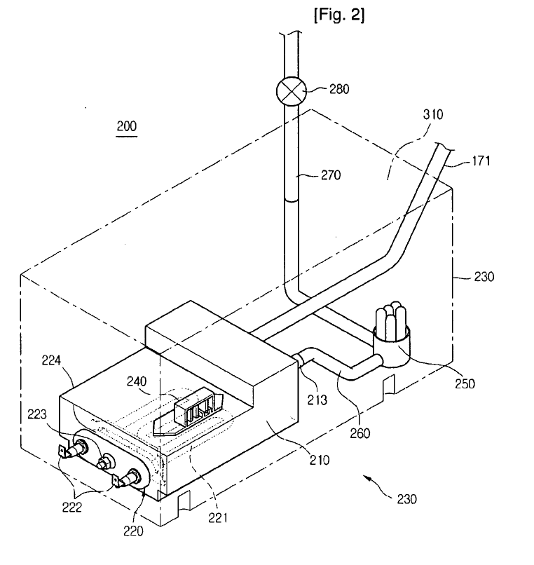

FIG. 2 is a perspective view of a steam generation unit according to an embodiment of the present invention.

Referring to FIG. 2, the steam generating unit 200 includes a housing, a water tank 210 that is received in the housing to reserve water used for steam, and a heater that is inserted in the water tank 210 to heat the water.

That is, a water supply tube 260 extends from a side of the water tank 210 and a solenoid valve 250 is installed on the water supply tube 260. The solenoid valve 250 adjusts a degree of opening of the water supply tube 260. A steam supply tube 171 extends from another side of the water tank 210 and is connected to the nozzle 180. Therefore, the steam generated in the water tank 210 is directed to the nozzle 180 and is subsequently supplied into the clothing receiving hole 130.

In addition, the heater 220 is installed inside the water tank 210 to heat the water reserved in the water tank 210, thereby generating the steam. That is, the heater 220 includes a heat pipe 221 that generates heat by electric power applied, a terminal 222 connecting the pipe 221 to a power source, and a fixing unit 223 for fixing the heater 220 to the water tank 210. Then, the water in the water tank chamber 211 is heated by the heat pipe 221. Meanwhile, a gap between the fixing unit 223 and the water tank 210 is sealed by a sealing member 224 to prevent the water from leaking out of the water tank 210.

A water level detecting unit 240 is installed in the water tank 210, extending into the water tank chamber 211 to detect the water level of the water tank chamber 211. The water level detecting unit 240 cooperates with the solenoid valve 250 to maintain the water level properly. In the water tank 210, a water temperature sensor may be further mounted in the water tank 210.

Meanwhile, the water supply tube 260 is connected to the water source tube. A water supply valve 280 is installed on the water source tube 270 to control the supply of the water. The water supply valve 280 may be a solenoid valve.

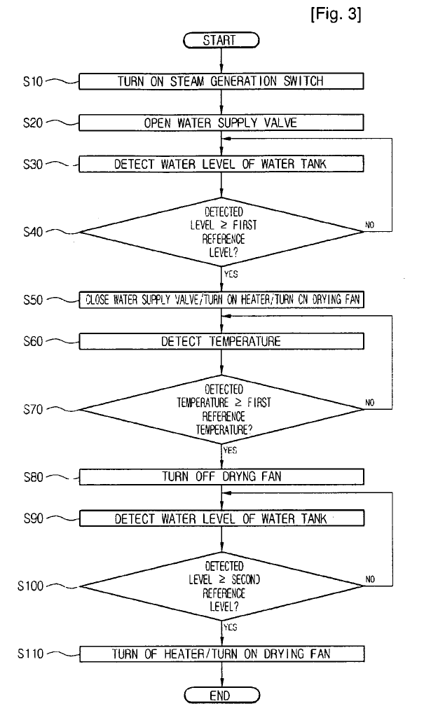

FIG. 3 is a flowchart illustrating a method of refreshing clothing according to a first embodiment of the present invention.

Referring to FIG. 3, when a steam generation switch is first turned on (S10), the water supply valve 280 is opened to start the water supply to the water tank (S20). At this point, the water level of the water tank 21 is detected by the water level detecting unit 240 (S30).

The detected water level is compared with a first reference water level (S40). The first reference level is a level when the water tank is fully filled with the water. When the detected water level is equal to or greater than the first reference level, the water supply valve 280 is closed and the heater 220 and the drying fan 173 are turned on (S50). Then, the external air is introduced by the drying fan 173 to perform the primary dry for the clothing received in the clothing receiving hole 130. Meanwhile, when the detected level is less than the first reference level, the water supply is continued (S30). A time point where the heater (220) is turned on and the drying fan 173 operates may be a time point where the water level reaches the level when the water tank is fully filled with the water or a time point where the water supply starts.

Meanwhile, when the water supply valve 280 is closed and the heater 220 and the drying fan 173 are turned on, the water temperature in the water tank 210 is detected (S60). The temperature detection may be performed by a predetermined temperature detecting sensor.

The detected water temperature is compared with a first reference temperature (S70). The first reference temperature is a temperature at which the water reserved in the water tank can be phase-changed into steam. For example, the reference temperature may be 100° C. When the detected temperature is equal to or greater than the first reference temperature, the drying fan is turned off (S80). Then, the drying process for the clothing loaded in the clothing receiving hole 130 is stopped and the steam supply is performed. Meanwhile, when the detected temperature is less than the first reference temperature, the heater 220 and the drying fan 173 keep their on-state to keep the heating of the water in the water tank 210 and the drying of the clothing. The temperature detecting is kept (S60).

During the steam is supplied, the water level of the water tank 210 is detected in-real time (S90). The detected level is compared with a second reference level (S100). The second reference level may be a level lower than a predetermined level. When the detected level is equal to or greater than the second reference level, the heater 220 is turned off and the drying fan 173 is turned on (S110). Then, the steam supply to the clothing loaded in the clothing receiving hole 130 is stopped and the drying of the clothing is performed again. Meanwhile, when the detected water level is less than the second reference level, the drying fan 173 keeps the off-state and the heater 220 keeps the on-state to continue the steam supply to the clothing. Then, the detecting of the water level is continued (S90).

During the one cycle including the primary drying, steam supply, and the secondary drying, the water supply to the water tank 210 is performed once. Therefore, the interruption of the steam supply due to the water supply does not occur, thereby reducing the time of the one cycle and enabling the continuous operation.

After the one cycle is finished, a cool wind drying may be further performed so as to reduce the temperature of the clothing heated by the steam, thereby improving the approaching to the clothing.

### MODE FOR THE INVENTION

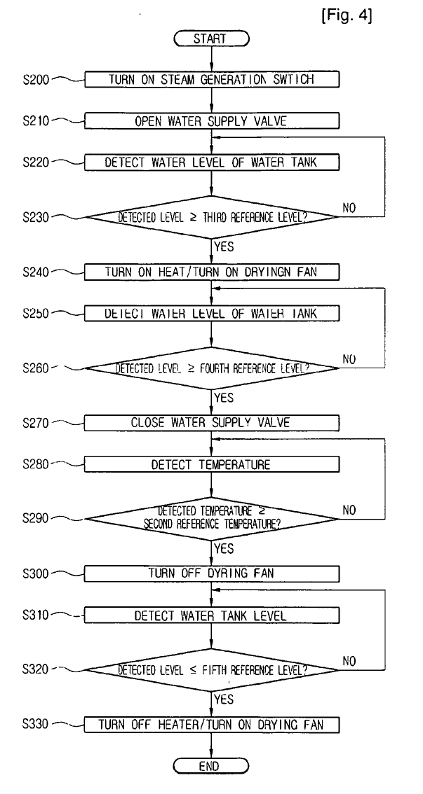

FIG. 4 is a flowchart illustrating a method of refreshing clothing according to a second embodiment of the present invention.

Referring to FIG. 4, when a steam generation switch is first turned on (S200), the water supply valve 280 is opened to start the water supply to the water tank 210 (S210). At this point, the water level of the water tank 21 is detected by the water level detecting unit 240 (S220).

The detected water level is compared with a third reference water level (S230). The first reference level is a level lower than a predetermined level. When the detected water level is equal to or greater than the third reference level, the heater 220 and the drying fan 173 are turned on (S240). Then, external air is introduced by the drying fan 173 to perform the primary drying for the clothing received in the clothing receiving hole 130. In addition, the water reserved in the water tank 210 is heated by the heater 220. The water supply valve 280 is opened to keep the water supply to the water tank 210. When the detected level is less than the third reference level, the water supply valve 280 keeps the opened state to keep the water supply. In addition, the detection of the water level by the water level detection unit 240 is kept (S220).

When the heater 220 and the drying fan 173 are turned on, the water level of the water tank 210 is continuously detected (S250).

The detected water level is compared with a fourth reference level (S260). The fourth reference level may be a level when the water tank is fully filled with the water. When the detected water level is equal to or greater than the fourth reference level, the water supply valve 280 is closed to stop the water supply to the water tank 210 (S270) and the heating of the water in the water tank 210 by the heater 220 and the primary drying by the drying fan 173 are kept. Meanwhile, when the detected level is less than the fourth reference level, the water supply valve 280 keeps the opened state to keep the water supply (S280). Then, the water level detection by the water level detection unit 240 is kept (S250).

When the water supply valve 280 is closed, the water temperature in the water tank 210 is detected.

The detected water temperature is compared with a second reference temperature (S290). The second reference temperature is a temperature at which the water reserved in the water tank can be phase-changed into steam. When the detected temperature is equal to or greater than the second reference temperature, the drying fan is turned off (S300). Then, the drying process for the clothing loaded in the clothing receiving hole 130 is stopped and the steam supply is performed. Meanwhile, when the detected temperature is less than the second reference temperature, the heater 220 and the drying fan 173 keep their on-state to keep the heating of the water in the water tank 210 and the drying of the clothing. The temperature detecting is kept (S280).

The drying fan 173 is turned off and the steam is supplied, the water level of the water tank 210 is detected (S310).

The detected level is compared with a fifth reference level (S320). When the detected level is equal to or greater than the fifth reference level, the heater 220 is turned off and the drying fan 173 is turned on (S330). Then, the steam supply to the clothing loaded in the clothing receiving hole 130 is stopped and the drying of the clothing is performed again. Meanwhile, when the detected water level is less than the fifth reference level, the drying fan 173 keeps the off-state and the heater 220 keeps the on-state to continue the steam supply to the clothing. Then, the detecting of the water level is continued (S310).

It will be apparent to those skilled in the art that various modifications and variations can be made in the present invention. Thus, it is intended that the present invention covers the modifications and variations of this invention provided they come within the scope of the appended claims and their equivalents.

### INDUSTRIAL APPLICABILITY

According to the present invention, after the water supply starts and the water level is lower than a predetermined level, the heater is turned on. When the water level reaches the full water level, the steam is generated. Therefore, the stand by time for the steam generation can be reduced. Therefore, the primary drying, steam supply and secondary drying can be continuously realized and the time for the one cycle can be reduced. Therefore, the industrial applicability of the present invention is very high.

1. A method of refreshing clothing, the method comprising:
primarily drying the clothing by operating a fan;
supplying steam generated by a steam generation unit to the clothing; and
drying the clothing by operating the fan after the steam is supplied.

2. The method according to claim 1, wherein the fan is driven at a time point when a water supply to the steam generation unit starts or a time point when the water supply to the steam generation unit is finished.

3. The method according to claim 1, wherein the heater is driven at a time point when a water level of the steam generation unit becomes higher than a reference level and when a water reaches a full water level.

4. The method according to claim 1, wherein the primarily drying of the clothing is performed until a temperature of the water stored in the steam generation unit reaches to a level where the water is phase-changed into the steam.

5. The method according to claim 1, wherein the driving of the fan is stopped at a point when the steam generation starts in the steam generation unit.

6. The method according to claim 1, wherein in the supplying of the steam, the driving of the heater is stopped when the water level of the steam generation unit is less than a predetermined reference level and the drying of the clothing is further performed.

7. The method according to claim 1, further comprising drying the clothing with cool air after the drying of the clothing.

8. A method of refreshing clothing, comprising:
drying the clothing during a period where water in a steam generation unit is heated up to a temperature at which the water can be phase-changed into steam.

9. The method according to claim 8, wherein the drying fan starts driving at a time point when the water supply to the steam generation unit starts and the driving of the drying fan is stopped at a time point when the steam supply starts.

10. The method according to claim 8, wherein the drying fan starts driving at a time point when the heat starts driving to generate the steam and the driving of the drying fan is stopped when the steam supply starts.

11. The method according to claim 8, wherein the driving of the heater is stopped when the water level of the steam generation unit is less than a predetermined reference level and the drying of the clothing is further performed by the operation of the drying fan.

12. The method according to claim 8, further comprising:
supplying steam after the drying of the clothing is finished; and
drying again the clothing after the steam supply is stopped.

13. The method according to claim 12, further comprising drying the clothing with cool air after the drying of the clothing.
